(19) United States
(12) Patent Application Publication
(10) Pub. No.: US 2023/0402680 A1
(43) Pub. Date: Dec. 14, 2023

(54) FLUIDS FOR IMMERSION COOLING OF ELECTRONIC COMPONENTS

(71) Applicant: 3M INNOVATIVE PROPERTIES COMPANY, St. Paul, MN (US)

(72) Inventors: Daniel Harrison, St. Paul, MN (US); Bamidele Fayemi, Cottage Grove, MN (US); Tyler Matthews, Apple Valley, MN (US); Michael Bulinski, Stillwater, MN (US)

(21) Appl. No.: 18/033,630

(22) PCT Filed: Oct. 28, 2021
(86) PCT No.: PCT/IB2021/059988

§ 371 Date: Apr. 25, 2023

Related U.S. Application Data
(60) Provisional application No. 63/198,670, filed on Nov. 3, 2020.

(51) Int. Cl. H01M 10/6567; H01M 50/204; H01M 10/613; H01M 10/625; C09K 5/10

(52) U.S. Cl. CPC H01M 10/6567; H01M 50/204; H01M 10/613; H01M 10/625; C09K 5/10; H01M 2220/20

(57) ABSTRACT

An electrochemical cell pack includes a housing having an interior space; a plurality of electrochemical cells disposed within the interior space; and a working fluid disposed within the interior space such that the electrochemical cells are in thermal communication with the working fluid. The working fluid has a dielectric constant of less than 3 and a dipole moment of less than 1.5 D.

### FIELD

The present disclosure relates to compositions useful for eliminating capacitive voltage in immersion cooling systems.

### BACKGROUND

Various fluids for use in immersion cooling are described in, for example, P. E. Tuma, “Fluoroketone C₂F₅C(O)CF(CF₃)₂ as a Heat Transfer Fluid for Passive and Pumped 2-Phase Applications,” 24th IEEE Semi-Therm Symposium, San Jose, CA, pp. 174-181, Mar. 16-20, 2008; and Tuma, P. E., “Design Considerations Relating to Non-Thermal Aspects of Passive 2-Phase Immersion Cooling,”, Proc. 27th IEEE Semi-Therm Symposium, San Jose, CA, USA, Mar. 20-24, 2011; and U.S. Pat. App. Pub. 2020/0178414.

### BRIEF DESCRIPTION OF THE FIGURES

FIG. 1 is a schematic view of an electrochemical cell module in accordance with some embodiments of the present disclosure.

FIG. 2 is a schematic view of an apparatus for measuring phantom voltage.

### DETAILED DESCRIPTION

Electrochemical cells (e.g., lithium-ion batteries) are in widespread use worldwide in a vast array of electronic and electric devices including hybrid and electric vehicles.

Direct contact liquid cooling of electrochemical cells has been identified as a means of improving thermal performance and safety. Desired properties for direct contact cooling fluids include low electrical conductivity, and low or non-flammability (i.e. no flash point). Many fluorinated hydrocarbons, such as partially or fully fluorinated fluorocarbons, fluoroethers, fluoroketones, and fluoroolefins have such desired properties.

It has been discovered that the interaction of electric fields with the molecular dipoles of certain of such cooling fluids is problematic in applications that include electrochemical cells. Asymmetric molecules possess permanent dipole moments due to unsymmetrical charge distribution within the molecular structure. The molecular dipoles respond to electric fields—the negatively polarized portion of the molecule is attracted to the positive terminal of the field, and vice versa. The ordering of the individual dipoles within the field results in a capacitive voltage, or phantom voltage, across the bulk material separating the electrodes of the electrochemical cell. In other words, the electric field is propagated through the material by the dipole interactions.

In direct contact liquid cooling of electrochemical cells for electric vehicles (EVs), which may referred to as immersion cooling, the electric vehicle battery packs and components of the battery packs such as bus bars and other current-carrying components contribute to a permanent electric field inside the pack (e.g., up to 800 volts DC). Immersion cooling fluids based on molecules with permanent dipole moments interact with the potential field, resulting in a phantom voltage in the bulk fluid, as detailed above. This voltage can induce current through the fluid, analogously to the behavior of a capacitor, although the capacitive current is very low because of the large distance between the terminals and the insulating properties of the fluid. The capacitive current is negligible compared the total current of the functioning battery and, therefore, not intrinsically detrimental to the operation of the battery. This capacitance current in purely DC applications is expected to decay to zero after an initial “power on” process has occurred.

Nevertheless, phantom voltage presents a significant problem to the immersion cooling of EV batteries. Typically, in high-voltage batteries such as those employed in electric vehicles, the initial connection circuitry and emergency shutdown features operate to disable the batteries if a short circuit is detected between the battery components and the battery pack ground. During battery start-up, electrical contacts are normally open such that the individual battery cells are not electrically connected to the battery control unit (BCU). A diagnostic circuit measures the voltage difference between the vehicle positive bus bar and the vehicle ground (or pack ground). Similarly, a diagnostic circuit measures the voltage difference between the vehicle negative bus bar and the vehicle ground (or pack ground). If the diagnostic circuit measures a short circuit condition between either of these two bus bars, a fault is issued and the electrical contacts are prevented from closing. If the bus bars and other charge-carrying components are insulated by air (dielectric constant=1.0, dipole moment=0), the resistance is sufficiently high (˜1 gigaohm) that the BCU detects zero voltage between the battery and ground and the pack functions normally. However, if the air is replaced by certain hydrofluoroethers (for example, Novec™ 7200 sold by 3M Company—dielectric constant=7.3, dipole moment=2.5), or other fluid with a permanent dipole ≥1.5 D, a phantom voltage appears and the resistance decreases by three orders of magnitude (˜1 megaohm). The BCU mistakenly interprets this situation as an actual short circuit between the battery and ground and, consequently, deactivates the battery.

Consequently, immersion cooling fluids for EV electrochemical cells or packs that have insulating, heat transfer, non-toxicity, non-flammability, pour point, boiling point properties and environmental profiles requisite of an effective cooling fluid in this application, and also have sufficiently low dielectric constants and correspondingly low dipole moments such that the phantom voltage phenomenon is eliminated, are desirable.

As used herein, “catenated heteroatom” means an atom other than carbon (for example, oxygen, nitrogen, or sulfur) that is bonded to at least two carbon atoms in a carbon chain (linear or branched or within a ring) so as to form a carbon-heteroatom-carbon linkage.

As used herein, “fluoro-” (for example, in reference to a group or moiety, such as in the case of “fluoroalkylene” or “fluoroalkyl” or “fluorocarbon”) or “fluorinated” means (i) partially fluorinated such that there is at least one carbon-bonded hydrogen atom, or (ii) perfluorinated.

As used herein, “perfluoro-” (for example, in reference to a group or moiety, such as in the case of “perfluoroalkylene” or “perfluoroalkyl” or “perfluorocarbon”) or “perfluorinated” means completely fluorinated such that, except as may be otherwise indicated, any carbon-bonded hydrogens are replaced by fluorine atoms.

As used herein, “perhalogenated” means completely halogenated such that, except as may be otherwise indicated, any carbon-bonded hydrogens are replaced by a halogen atom.

As used herein, the singular forms “a”, “an”, and “the” include plural referents unless the content clearly dictates otherwise. As used in this specification and the appended embodiments, the term “or” is generally employed in its sense including “and/or” unless the content clearly dictates otherwise.

As used herein, the recitation of numerical ranges by endpoints includes all numbers subsumed within that range (e.g. 1 to 5 includes 1, 1.5, 2, 2.75, 3, 3.8, 4, and 5).

Unless otherwise indicated, all numbers expressing quantities or ingredients, measurement of properties and so forth used in the specification and embodiments are to be understood as being modified in all instances by the term “about.” Accordingly, unless indicated to the contrary, the numerical parameters set forth in the foregoing specification and attached listing of embodiments can vary depending upon the desired properties sought to be obtained by those skilled in the art utilizing the teachings of the present disclosure. At the very least, and not as an attempt to limit the application of the doctrine of equivalents to the scope of the claimed embodiments, each numerical parameter should at least be construed in light of the number of reported significant digits and by applying ordinary rounding techniques.

In some embodiments, the present disclosure may be directed to compositions, or working fluids, that include a hydrofluoroolefin compound having the following Structural Formula (IA):

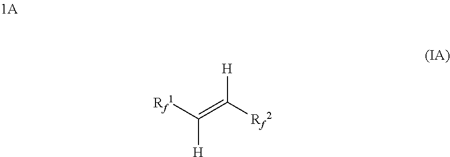

It was discovered that the alkylene segment of Structural Formula (IA), namely an alkylene segment in which each carbon of the segment is bonded to one hydrogen atom and one perhalogenated moiety in the E (or trans) configuration, provides surprisingly low dielectric constants of less than 2.5. No other hydrofluoroolefin structures have been found which provide similarly low dielectric constants. It has been further discovered that these hydrofluorolefin compounds have dipole moments and dielectric constants that render them particularly suitable for use as working fluids in immersion cooling systems, particularly those used for the immersion cooling of electric vehicles.

In some embodiments, each R_{f}¹ and R_{f}² may be, independently, (i) a linear or branched perhalogenated acyclic alkyl group having 1-6, 2-5, or 3-4 carbon atoms and optionally contain one or more catenated heteroatoms selected from O or N; or (ii) a perhalogenated 5-7 membered cyclic alkyl group having 3-7 or 4-6 carbon atoms and optionally containing one or more catenated heteroatoms selected from O or N. In some embodiments, each perhalogenated R_{f}¹ and R_{f}² may be substituted with only fluorine atoms or chlorine atoms. In some embodiments, each perhalogenated R_{f}¹ and R_{f}² may be substituted with only fluorine atoms and one chlorine atom. In some embodiments, R_{f}¹ and R_{f}² may be the same perfluorinated alkyl groups (acyclic or cyclic, including any catenated heteroatoms).

It is to be appreciated that the hydrofluoroolefin compounds of Structural Formula (IA) represent the E (or trans) isomer of a hydrofluoroolefin that can exist in two isomeric forms, the other isomeric form being the Z (or cis) isomer, depicted in Structural Formula (IB):

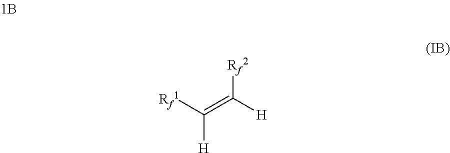

In some embodiments, the compositions of the present disclosure may be rich in the isomer of Structural Formula (IA) (the E isomer). In this regard, in some embodiments, the compositions of the present disclosure may include hydrofluoroolefins having Structural Formula (IA) in an amount of at least 85, 90, 95, 96, 97, 98, 99, or 99.5 weight percent, based on the total weight of the hydrofluoroolefins having Structural Formula (IA) and (IB) in the composition.

In various embodiments, representative examples of the compounds of general formula (I) include the following:

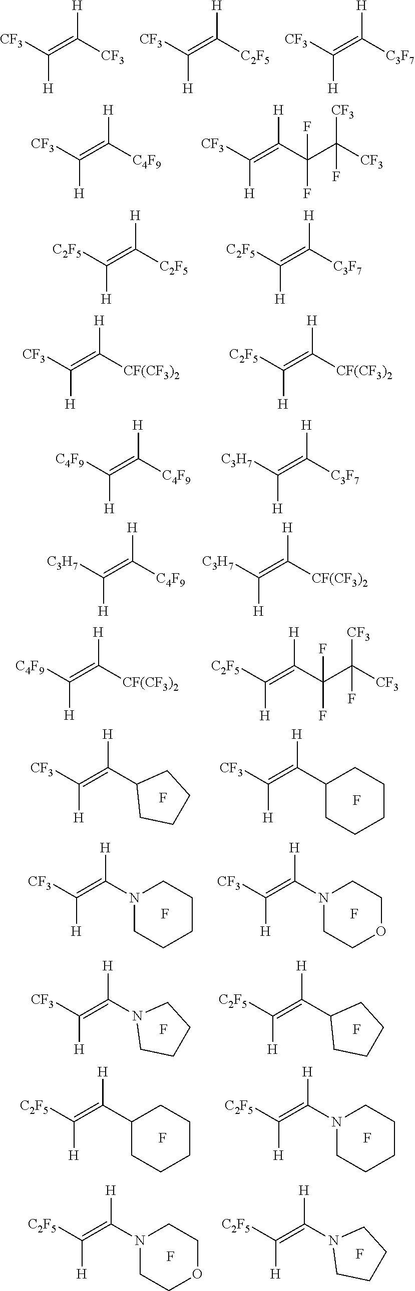

In some embodiments, the hydrofluoroolefin compounds of the present disclosure may be hydrophobic, relatively chemically unreactive, and thermally stable. The hydrofluoroolefin compounds may have a low environmental impact. In this regard, the hydrofluoroolefin compounds of the present disclosure may have a zero, or near zero, ozone depletion potential (ODP) and a global warming potential (GWP, 100yr ITH) of less than 500, 300, 200, 100 or less than 10. As used herein, GWP is a relative measure of the global warming potential of a compound based on the structure of the compound. The GWP of a compound, as defined by the Intergovernmental Panel on Climate Change (IPCC) in 1990 and updated in 2007, is calculated as the warming due to the release of 1 kilogram of a compound relative to the warming due to the release of 1 kilogram of CO₂ over a specified integration time horizon (ITH).

$${GWP}_{i} ( {t}^{′} ) = \frac{{{\int }_{0}}^{ITH} {a}_{i} [ C ( t ) ] dt}{{{\int }_{0}}^{ITH} {a}_{{CO}_{2}} [ {C}_{{CO}_{2}} ( t ) ] dt} = \frac{{{\int }_{0}}^{ITH} {a}_{i} {C}_{oi} {e}^{- t / {τ}_{i}} dt}{{{\int }^{ITH}}_{0} {a}_{{CO}_{2}} [ {C}_{{CO}_{2}} ( t ) ] d t}$$

In this equation aᵢ is the radiative forcing per unit mass increase of a compound in the atmosphere (the change in the flux of radiation through the atmosphere due to the IR absorbance of that compound), C is the atmospheric concentration of a compound, τ is the atmospheric lifetime of a compound, t is time, and i is the compound of interest. The commonly accepted ITH is 100 years representing a compromise between short-term effects (20 years) and longer-term effects (500 years or longer). The concentration of an organic compound, i, in the atmosphere is assumed to follow pseudo first order kinetics (i.e., exponential decay). The concentration of CO₂ over that same time interval incorporates a more complex model for the exchange and removal of CO₂ from the atmosphere (the Bern carbon cycle model).

In some embodiments, the fluorine content in the hydrofluoroolefin compounds of the present disclosure may be sufficient to make the compounds non-flammable according to ASTM D-3278-96 e-1 test method (“Flash Point of Liquids by Small Scale Closed Cup Apparatus”).

In some embodiments, the hydrofluoroolefin compounds represented by Structural Formula (IA) can be synthesized by the methods described in WO2009079525, WO 2015095285, U.S. Pat. No. 8,148,584, J. Fluorine Chemistry, 24 (1984) 93-104, and WO2016196240.

In some embodiments, the compositions, or working fluids, of the present disclosure may include at least 25%, at least 50%, at least 70%, at least 80%, at least 90%, at least 95%, or at least 99% by weight of the above-described hydrofluoroolefins of Formula (IA), based on the total weight of the composition. In addition to the hydrofluoroolefins, the compositions may include a total of up to 75%, up to 50%, up to 30%, up to 20%, up to 10%, up to 5%, or up to 1% by weight of one or more of the following components (individually or in any combination): ethers, alkanes, perfluoroalkenes, alkenes, haloalkenes, perfluorocarbons, perfluorinated tertiary amines, perfluoroethers, cycloalkanes, esters, perfluoroketones, ketones, oxiranes, aromatics, siloxanes, hydrochlorocarbons, hydrochlorofluorocarbons, hydrofluorocarbons, hydrofluoroolefins, hydrochloroolefins, hydrochlorofluoroolefins, hydrofluoroethers, or mixtures thereof based on the total weight of the working fluid; or alkanes, perfluoroalkenes, haloalkenes, perfluorocarbons, perfluorinated tertiary amines, perfluoroethers, cycloalkanes, perfluoroketones, aromatics, siloxanes, hydrochlorocarbons, hydrochlorofluorocarbons, hydrofluorocarbons, hydrofluoroolefins, hydrochlorofluoroolefins, hydrofluoroethers, or mixtures thereof, based on the total weight of the working fluid. Such additional components can be chosen to modify or enhance the properties of a composition for a particular use.

In some embodiments, the compositions, or working fluids of the present disclosure may have dielectric constants that are less than 3, less than 2.5, less than 2.4, less than 2.3, less than 2.2, less than 2.1, less than 2.0, or less than 1.9, as measured in accordance with ASTM D150 at room temperature.

In some embodiments, the compositions, or working fluids of the present disclosure may have dipole moments of less than 1.5 debyes (D), less than 1.25 D, or less than 1.0 D, as measured in accordance with the “Determination of Dipole Moments” section of the Examples of the present disclosure.

In some embodiments, the compositions or working fluids of the present disclosure may have a boiling point between 30-75° C., or 35-75° C., 40-75° C., or 45-75° C. In some embodiments, the compositions or working fluids of the present invention may have a boiling point greater than 40° C., or greater than 50° C., or greater than 60° C., greater than 70° C., or greater than 75° C.

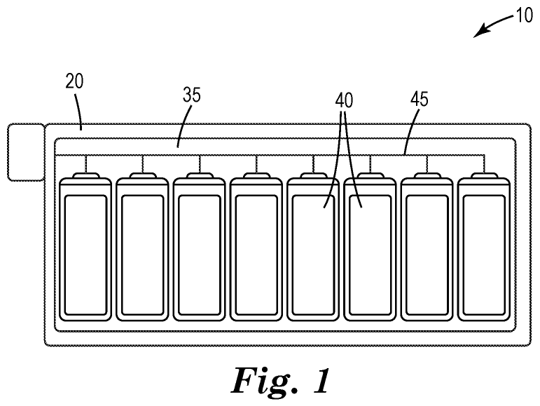

In some embodiments, the present disclosure is directed to an electrochemical cell module (or pack) that includes the working fluids of the present disclosure. With reference to FIG. 1, the electrochemical cell module 10 may include a housing 20 that defines an interior volume 35 that contains a plurality of electrochemical cells 40. The electrochemical cells 40 that may be electrically coupled to each other via a busbar 45. A working fluid may be disposed within the interior volume 35 such that the working fluid is in thermal communication with one or more (up to all) of the electrochemical cells 40. Thermal communication may be achieved via direct contact immersion. In embodiments in which direct contact immersion is employed, the working fluid may surround and directly contact any portion (up to totally surround and directly contact) one or more (up to all) of the electrochemical cells. In some embodiments, the electrochemical cells may be rechargeable batteries (e.g., rechargeable lithium-ion batteries). In some embodiments, the interior volume 35 may be fluidically sealed such that other than any desired venting, the working fluid is maintained within the interior volume 35.

In some embodiments, the electrochemical cells may be prismatic cells. Prismatic cells are electrochemical cells which contain electrodes in a stacked or layered form, often contained in a rectangular housing or “can.” These cells are often used because they have a thin design and can better utilize the available space, improving the density and capacity of battery modules. A typical prismatic automotive cell has flat, metallic terminal pads, allowing various types of connection hardware to be welded to them. Alternatively, the electrochemical cells may be, for example, cylindrical cells or pouch cells.

In some embodiments, the working fluid may be disposed within the interior volume 35 such that substantially the entirety (e.g., at least 80%, at least 90%, at least 95%, or at least 99%) of the interior volume 35 that is not occupied by electrochemical cells 40 (or any other solid components within the housing) is occupied by the working fluid.

In some embodiments (not depicted), the electrochemical cell module 10 may be a component of a fluidic circuit configured to control the temperature of the working fluid. For example, the interior volume 35 may be in fluid communication with a fluidic circuit that also includes one or more heat exchangers and one or more pumps. The one or more pumps may cause the working fluid to move through the fluidic circuit, passing through the interior volume 35, where it collects heat generated from operation of the electrochemical cells. The working fluid may then be routed to a heat exchanger, which removes the heat from the working fluid before returning it to the fluidic circuit. It is to be appreciated that this arrangement of the components is one possible configuration for controlling the temperature of the working fluid, and is not meant to be limiting. Alternatively, in some embodiments, the working fluid may remain in the electrochemical cell modules 10 and not be a part of an active temperature control system (i.e., the working fluid may not be in fluid communication with a pump and/or heat exchanger).

In some embodiments, the electrochemical cell modules 10 of the present disclosure may be may be configured to store and supply electrical power to an electrical system, such as in a Battery Electric Vehicle (BEV), a Plug-in Hybrid Electric Vehicle (PHEV), a hybrid electric vehicle (HEV), an Uninterruptible Power Supply (UPS) system, a residential electrical system, an industrial electrical system, a stationary energy storage system, or the like.

The operation of the present disclosure will be further described with regard to the following detailed examples. These examples are offered to further illustrate various embodiments and techniques. It should be understood, however, that many variations and modifications may be made while remaining within the scope of the present disclosure.

### Examples

The present disclosure is more particularly described in the following examples that are intended as illustrations only, since numerous modifications and variations within the scope of the present disclosure will be apparent to those skilled in the art. Unless otherwise noted or readily apparent from the context, all parts, percentages, ratios, etc. in the Examples and the rest of the specification are by weight.

### Materials Used in the Examples

| Material | Source |
|---|---|
| FC-3283 | Perfluoro-trialkylamines, primarily N(C₃F₇)₃, |
| | available under the trade designation, |
| | “FLUORINERT FC-3283 ELECTRONIC |
| | FLUID”, from3M Company, Maplewood, |
| | MN |
| OPTEON SF10 | CH₃O(C₇F₁₃); Methoxytridecafluoro-heptene, |
| | multiple isomers, available under the trade |
| | designation, “OPTEON SF10”, from |
| | The Chemours Company, Wilmington, DE. |
| NOVEC 7200 | A blend of CH₃CH₂O(n-C₄F₉); 1-ethoxy- |
| | 1,1,2,2,3,3,4,4,4-nonafluorobutane and |
| | CH₃CH₂O(s-C₄F₉), 1-ethoxy-1,1,2,3,3,3- |
| | hexafluoro-2-(trifluoromethyl)propane, |
| | available under the trade designation, |
| | “NOVEC 7200”, from 3M Company. |
| NOVEC 7300 | CH₃OCF(OCH₃)(i-C₃F₇); 1,1,1,2,2,3,4,5,5,5- |
| | decafluoro-3-methoxy-4-(trifluoromethyl)- |
| | pentane, available under the trade designation, |
| | “NOVEC 7300”, from 3M Company. |
| NOVEC 1230 | O═C(C₂F₅)(i-C₃F₇); 1,1,1,2,2,4,5,5,5- |
| | nonafluoro-4-(trifluoromethyl)pentan-3-one, |
| | available under the trade designation, |
| | “NOVEC 1230”, from 3M Company. |
| (Z)-1,1,1,4,4,4-hexafluorobut-2-ene, | Available from Beijing Yuji Science & |
| cis-CF₃CH═CHCF₃ (≥99.0%) | Technology Company, Beijing, China. |
| Dibenzoyl peroxide (97% dry | Available from Alfa Aesar, Haverhill, MA. |
| weight (wt), 25 wt % water) | |
| 2-Iodoheptafluoropropane | Available from SynQuest, Alachua, Florida. |
| (97%) | |
| 3,3,3-Trifluoropropene | Available from SynQuest. |
| (99%) | |
| Isopropanol | Available from VWR International, Radnor, PA. |
| Potassium hydroxide | Available from Sigma Aldrich, St. Louis, MO. |

### Test Methods and Preparation Procedures

Preparation of Perfluorodiethylsulfone, [SO₂(C₂F₅)₂]

Perfluorodiethylsulfone was prepared following the procedure disclosed in U.S. Pat. No. 6,580,006, which is incorporated herein by reference in its entirety.

### Preparation of (E)-1,1,1,4,5,5,5-heptafluoro-4-(trifluoromethyl)pent-2-ene, trans-CF₃CH═CH[CF(CF₃)₂

HFO-153-10mzzy was made using a variation of the published two step procedure disclosed in U.S. Pat. No. 8,148,584, which in incorporated herein by reference in its entirety.

Step 1. Dibenzoyl peroxide (97% dry weight, wet with 25 wt % water, 3.0 g, 9.0 mmol) was added to a stainless steel 600 mL Parr reactor, equipped with a pressure gauge, overhead stirring mechanism, temperature probe, vapor and dip-tube valves, and 68 atm (6890 kPa) rupture disc. The reactor was sealed and cooled in dry ice for 15 minutes, then evacuated while cold. 2-Iodoheptafluoropropane (97/6, 490 g, 1610 mmol) and 3,3,3-trifluoropropene (99%, 138 g, 1440 mmol) were added to the cooled/evacuated reactor. With stirring, the internal temperature was gradually brought to 80° C., over 1 hour, and held at this temperature overnight. The pressure inside the reactor peaked at ˜11 atm (1110 kPa) and came down to ≤1.1 atm (111 kPa) overnight. The crude product was purified by distillation through a 20-stage Oldershaw column, producing 1,1,1,2,5,5,5-heptafluoro-4-iodo-2-(trifluoromethyl)pentane (boiling point ˜115° C., 1 atm (101 kPa)) with ≥98% purity by gas chromatography-flame ionization detector (GC-FID) which was used in the next step.

Step 2. In a 3-neck 1 L round-bottom flask equipped with magnetic stirrer, thermal probe, cold water condenser and addition funnel, under an atmosphere of nitrogen 1,1,1,2,5,5,5-heptafluoro-4-iodo-2-(trifluoromethyl)pentane (401 g, 1020 mmol) and isopropanol (510 mL) were combined to give a yellow solution. With vigorous stirring, aqueous potassium hydroxide (158 g, 36.7 wt %, 1030 mmol) was added dropwise by addition funnel (˜1 drop/3-4 seconds, exothermic), while keeping the internal temperature between 20 and 30° C. during the addition. Stirring was continued at ambient temperature overnight, giving a yellow suspension. The crude mixture was shaken with water (800 mL) in a 2 L separatory funnel; the solid material dissolved to afford two liquid phases. The fluorochemical (bottom) layer was separated and purified by steam distillation producing HFO-153-10mzzy. The structure and purity (>99%) were confirmed by proton (¹H) and fluorine (¹⁹F) NMR spectroscopy. The peak for the desired HFO accounted for 99.8% area of the GC-FID trace.

### Preparation of (E)- and (Z)-1,2,3,3,3-pentafluoro-1-(perfluoropropoxy)prop-1-ene, i.e. (E)- and (Z)—CF₃CF═CF(O-n-C₃F₇)

1,2,3,3,3-Pentafluoro-1-(perfluoropropoxy)prop-1-ene was prepared as a ˜1:1 mixture of E and Z isomers following the procedure disclosed in PCT Publ. Appl. No. WO 2019/116260 A1, which is incorporated herein by reference in its entirety.

### Determination of Dipole Moments:

Dipole moments were obtained from literature sources, where possible, as indicated in the Tables 1-3. In some cases, the dipole moments were computed for the lowest energy conformers, using Density Functional Theory (DFT) methods (DFT, BP86/CC-PVTZ-f).

### Determination of Dielectric Constants:

Dielectric constants were obtained from the suppliers' datasheets or other literature sources, except where noted. In some cases, the dielectric constants were measured as follows:

Dielectric constants were measured using an Alpha-A High Temperature Broadband Dielectric Spectrometer (Novocontrol Technologies, Montabaur, Germany) in accordance with ASTM D150-11, “Standard Test Methods for AC Loss Characteristics and Permittivity (Dielectric Constant) of Solid Electrical Insulation.” The parallel plate electrode configuration was selected for this measurement. The sample cell of parallel plates, an Agilent 16452A liquid test fixture consisting of 38 mm diameter parallel plates (Keysight Technologies, Santa Rosa, CA, US) was interfaced to the Alpha-A mainframe while utilizing the ZG2 Dielectric/Impedance General Purpose Interface available from Novocontrol Technologies. Each sample was prepared between parallel plate electrodes with a spacing, d, (typically, d=1 mm) and the complex permittivity (dielectric constant and loss) were evaluated from the phase sensitive measurement of the electrodes voltage difference (Vs) and current (Is). Frequency domain measurements were carried out at discrete frequencies from 0.00001 Hz to 1 MHz. Impedances from 10 milliohms up to 1×10¹⁴ ohms were measured up to a maximum of 4.2 volts AC. For this experiment, however, a fixed AC voltage of 1.0 volts was used. The DC conductivity (the inverse of volume resistivity) was extracted from an optimized broadband dielectric relaxation fit function that contained at least one term of the low frequency Havrrilak Negami dielectric relaxation function and one separate frequency dependent conductivity term.

### Determination of Phantom Voltages:

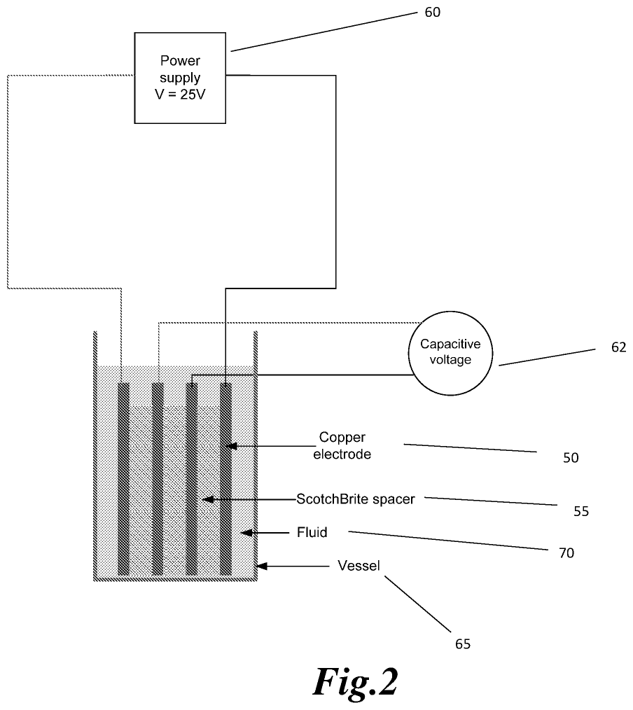

With reference to FIG. 2, four sheets of copper 50 measuring roughly 2 cm×6 cm×0.04 cm (width×length×thickness) were arranged in a parallel configuration and separated by 5 mm thick pieces of a SCOTCH-BRITE Heavy Duty Scour Pad 55 (3M Company, Maplewood, MN). The SCOTCH-BRITE pads 55 served to electrically isolate each plate 50 and provide a porous, fluid-permeable matrix between the electrodes, see FIG. 2. Electrical leads were connected to the outermost two electrodes which in turn were connected to the positive and negative terminals of a DC power supply 60 (Model 9110 100 W Multiamp, BK Precision). The innermost two electrodes were connected to a digital multimeter 62 (Model 117 True RMS Handheld, Fluke) via test clips. The copper electrode and SCOTCH-BRITE pad assembly was then placed inside a 100 mL tri-cornered polypropylene beaker 65 (Fisher Scientific). The 100 mL beaker was placed inside a larger 250 mL tri-cornered polypropylene beaker. The 250 mL beaker was partially filled with house water cooled to 0° C. with ice. In this way, the fluid contents of the inner 100 mL beaker were kept to˜0° C. to minimize evaporation over the course of the experiment. The 100 mL beaker was then filled to the 80 mL mark with the appropriate fluid 70, thereby covering a large percentage of the copper electrodes. A DC input voltage of 25 V was applied to the outer two electrodes using the DC power supply. The phantom voltage was measured across the inner two electrodes using the multimeter in a DC voltage setting.

### Examples

Table 1 lists the dipole moments, dielectric constants and phantom voltages (measured as described above) for representative cis and trans (i.e., Z and E) HFOs. The cis HFO (Ex. 1) had a dipole moment of 2.8 D and gave a phantom voltage of 5.40 V. On the other hand, the trans HFO (Ex. 2) had a much smaller dipole moment of 0.3 D which led to a phantom voltage of 0.00 V.

TABLE 1

| | | | Boiling point | μ, Dipole | ε, Dielectric | Phantom |
|---|---|---|---|---|---|---|
| | | | (° C., 1 atm | moment | Constant at | Voltage |
| Example | Molecular structure | Chemical name | (101 kPa)) | (D) | 1 kHz | (V) |
| Ex. 1 | 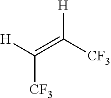 | (Z)-1,1,1,4,4,4- hexafluorobut-2- ene | 35 | 2.8 (Ref. 1) | 17 | 5.40 |
| Ex. 2 | 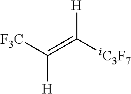 | (E)-1,1,1,4,5,5,5- heptafluoro-4- (trifluoromethyl) pent-2-ene | 49 | 0.3 (Ref. 1) | 1.9 | 0.00 |

Ref. 1: Calculated as described in the “Determination of Dipole Moments” section, above.

### Comparative Examples 3-9 (CE3-CE9)

Table 2 lists the dipole moments, dielectric constants and phantom voltages (measured as described above) for representative fluorinated fluids, to further illustrate the relationships between these quantities. Based on the data in Tables 1-3, materials having dipole moments ≤0.7 D give phantom voltages of ≤0.00 V. Thus, such materials (including CE7-CE9) are especially suitable as electric vehicle (EV) battery coolants or other high voltage applications where phantom voltage is problematic.

TABLE 2

| | | Boiling | | ε, | |
|---|---|---|---|---|---|
| | | point (° C., | | Dielectric | Phantom |
| Comparative | | 1 atm (101 | μ, Dipole | Constant | voltage |
| Example | Material | kPa)) | moment (D) | at 1 kHz | (V) |
| CE3 | OPTEON SF10 | 110 | 2.2 (Ref. 2) | 5.5 | 7.15 |
| CE4 | NOVEC 7200 | 76 | 2.5 (Ref. 3) | 7.3 | 5.75 |
| CE5 | NOVEC 7300 | 98 | 2.3 (Ref. 4) | 6.1 | 6.59 |
| CE6 | Perfluorodiethylsulfone | 64 | 1.7 (Ref. 1) | 3.2 | 0.05 |
| CE7 | (E)- and (Z)-1,2,3,3,3- | 60 | 0.7 (Ref. 5) | 2.0 | 0.00 |
| | pentafluoro-1- | | | | |
| | (perfluoropropoxy)prop-1- | | | | |
| | ene | | | | |
| CE8 | NOVEC 1230 | 49 | 0.4 (Ref. 6) | 1.8 | 0.00 |
| CE9 | FC-3283 | 128 | ≤0.1 (Ref. 1) | 1.9 | 0.00 |

Ref. 1: Calculated as described in the “Determination of Dipole Moments” section, above.
Ref. 2.: Weighted average of four main isomers, calculated as described in the “Determination of Dipole Moments” section, above.
Ref. 3: Chu, Q.; Yu, M. S.; Curran, D. P. Tetrahedron 2007, 63, 9890-9895.
Ref. 4: Rausch, M. H.; Kretschmer, L.; Will, S.; Leipertz, A.; Fröba, A. P. J. Chem. Eng. Data 2015, 60, 3759-3765.
Ref. 5: Weighted average of E and Z isomers, calculated as described in the “Determination of Dipole Moments” section, above.
Ref. 6: Wen, C.; Meng, X.; Huber, M. L.; Wu, J. J. Chem. Eng. Data 2017, 62, 3603-3609.

### Prophetic Examples

Table 3 lists the boiling points, dipole moments and dielectric constants for representative HFOs. The prophetic examples with trans (E) double bond configurations (PE1-PE5) have dipole moments <0.7 and, consequently, are expected to give phantom voltages of <0.00 (determined as described above). These materials, and related trans HFOs, are predicted to be suitable for high voltage electronics applications in which phantom voltage is undesirable. Specifically, trans HFOs with dipole moments ≤0.7 are anticipated to be useful as EV battery coolants, in single-phase immersion cooling applications (boiling points from ˜80 to 200° C., including PE4 and PE5) or two-phase immersion cooling applications (boiling points from˜30 to 80° C., including PE1-PE3).

For comparison, representative HFOs lacking the trans configuration, comparative prophetic examples 6-8 (CPE6-CPE8), are also presented in Table 3. These compounds have dipole moments ≥1.3 and, consequently, are expected to give phantom voltages of ≥0.00 (determined as described above). Generally, HFOs that deviate from the trans configuration possess larger dipole moments than their trans analogs and, therefore, are likely to be unsuitable for high voltage electronics applications in which phantom voltage is problematic.

TABLE 3

| | | | Boiling point | | Dielectric |
|---|---|---|---|---|---|
| Prophetic | Molecular | | (° C., 1 atm | Dipole | constant, ε |
| example | structure | Chemical name | (101 kPa)) | moment, μ (D) | (at 1 kHz) |
| PE1 | 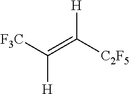 | (E)-1,1,1,4,4,5,5,5- octafluoropent-2-ene | 33 | 0.1 (Ref. 1) | 2.1 |
| PE2 | 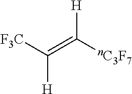 | (E)- 1,1,1,4,4,5,5,6,6,6- decafluorohex-2-ene | 53 | ≤0.3 (Ref. 7) | ≤2 (Ref. 7) |
| PE3 | 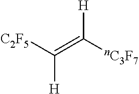 | (E)- 1,1,1,2,2,5,5,6,6,7,7, 7-dodecafluorohept- 3-ene | 73 | ≤0.3 (Ref. 7) | ≤2 (Ref. 7) |
| PE4 | 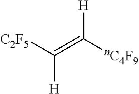 | (E)- 1,1,1,2,2,5,5,6,6,7,7, 8,8,8- tetradecafluorooct-3- ene | 95 | ≤0.3 (Ref. 7) | ≤2 (Ref. 7) |
| PE5 | 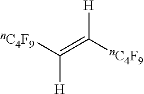 | (E)- 1,1,1,2,2,3,3,4,4,7,7, 8,8,9,9,10,10,10- octadecafluorodec-5- ene | 150 | 0.0 (Ref. 1) | 1.9 |
| CPE6 | 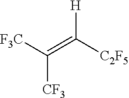 | 1,1,1,4,4,5,5,5- octafluoro-2- (trifluoromethyl) pent-2-ene | 53 | 1.3 | 3.0 |
| CPE7 | 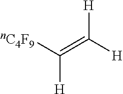 | 3,3,4,4,5,5,6,6,6- nonafluorohex-1-ene | 59 | 2.5 (Ref. 1) | 5.8 |
| CPE8 | 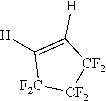 [SMILES: FC1(F)C=CC(F)(F)C1(F)F] | (Z)-3,3,4,4,5,5- hexafluorocyclopent- 1-ene | 72 | 3.2 (Ref. 1) | 20 |

Ref. 1: Calculated as described in the “Determination of Dipole Moments” section, above.
Ref. 7: Estimated based on the values of Ex. 2, PE1 and PE5.

1. An electrochemical cell pack comprising:
a housing having an interior space;
a plurality of electrochemical cells disposed within the interior space; and
a working fluid disposed within the interior space such that the electrochemical cells are in thermal communication with the working fluid;
wherein the working fluid has a dielectric constant of less than 3 and a dipole moment of less than 1.5 D.

2. The electrochemical cell pack of claim 1, wherein the working fluid comprises a compound having Structural Formula (IA) 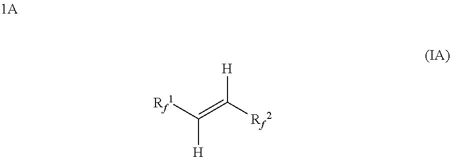
wherein each R_{f}¹ and R_{f}² is, independently, (i) a linear or branched perhalogenated acyclic alkyl group having 1-6 carbon atoms and optionally contains one or more catenated heteroatoms selected from O or N; or (ii) a perhalogenated 5-7 membered cyclic alkyl group having 3-7 carbon atoms and optionally contains one or more catenated heteroatoms selected from O or N.

3. The electrochemical cell pack of claim 1, wherein the working fluid has an electrical conductivity (at 25 degrees Celsius) of less than 1e-5 S/cm.

4. The electrochemical cell pack of claim 1, wherein the working fluid comprises fluorinated compounds in an amount of at least 50 wt. %, based on the total weight of the working fluid.

5. An electrical power system comprising:
the electrochemical cell pack of claim 1; and
an electrical load, wherein the electrochemical cell pack is electrically coupled to the electrical load.

6. The electrochemical cell pack of claim 5, wherein the electrical load is a motor for propelling an electric vehicle.

7. A method for cooling an electrochemical cell pack comprising a plurality of electrochemical cells, the method comprising:
at least partially immersing the electrochemical cells in a working fluid; and
transferring heat from the electrochemical cells using the working fluid;
wherein the working fluid has a dielectric constant of less than 3 and a dipole moment of less than 1.5 D.

8. The method of claim 7, wherein the working fluid comprises a compound having Structural Formula (IA) 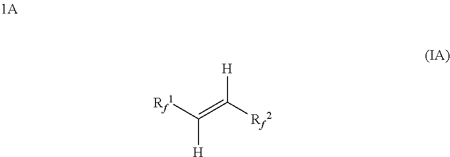
wherein each R_{f}¹ and R_{f}² is, independently, (i) a linear or branched perhalogenated acyclic alkyl group having 1-6 carbon atoms and optionally contains one or more catenated heteroatoms selected from O or N; or (ii) a perhalogenated 5-7 membered cyclic alkyl group having 3-7 carbon atoms and optionally contains one or more catenated heteroatoms selected from O or N.
